(19) United States
(12) Patent Application Publication
(10) Pub. No.: US 2013/0312623 A1
(43) Pub. Date: Nov. 28, 2013

(54) FIBER FLOW CONTROLLED CENTRIFUGAL BOWL MECHANISM

(71) Applicants: Shu Sang CHEUNG, Guangdong Province (CN); To Yin Pang, Guangdong Province (CN)

(72) Inventors: Shu Sang CHEUNG, Guangdong Province (CN); To Yin Pang, Guangdong Province (CN)

(21) Appl. No.: 13/898,487

(22) Filed: May 21, 2013

(30) Foreign Application Priority Data
May 25, 2012 (CN) 201220238737.3

(51) Int. Cl. A23N 1/02

(52) U.S. Cl. CPC A23N 1/02
USPC 99/503

(57) ABSTRACT

A fiber flow controlled centrifugal bowl mechanism comprises a centrifugal bowl and a mesh filter bracket sleeved at the bottom of the centrifugal bowl. A grating disk is installed between the bottom of the centrifugal bowl and the mesh filter. The upper surface of the grating disk is provided with cutting teeth, the lower part of the centrifugal bowl is provided with mesh holes allowing fibers to pass and the mesh size is adjustable. The utility model has the following advantages: 1, the centrifugal bowl and mesh filter of the juicer can rotate relatively to adjust the size of the mesh holes; 2, the fiber flow can be controlled through the mesh holes, so beverages containing different fibers can be provided; and 3, the mesh size can be quickly fixed by installing a locating structure, so the juicer is quick to adjust and convenient to use.

### BACKGROUND OF THE INVENTION

The utility model relates to technology for improving the centrifugal bowl mechanism of a juicer.

Modern society has increasing demands on intake of fruits and vegetables which are rich in vitamins and water-soluble dietary fibers greatly beneficial to human health. The water-soluble dietary fibers can effectively reduce blood fat, adjust blood sugar and lower the risks of diseases such as heart attack. In the prior art, the centrifugal bowl mechanism of the juicer has the disadvantages of fixed mesh size, single juice output and single juice variety and cannot achieve the desirable juicing effect by adjusting the centrifugal bowl. The defects of the prior art lie in: 1, the centrifugal bowl of the juicer adopts a single layer of fixed mesh holes and cannot adjust the juice output and juicing degree; 2, in the dual mesh filter tool disk structure of the juicer, the structures of the internal and external mesh filter and mesh holes are completely identical, resulting in single juicing and filtering functions; 3, the centrifugal bowl of the juicer can only be used as a filter part and cannot adjust and control the fiber flow of the juice.

### BRIEF SUMMARY OF THE INVENTION

On that account, the technical problem that the utility model needs to solve is to provide a centrifugal bowl mechanism which can adjust the mesh size and control the fiber flow and is convenient to use.

The utility model is realized by the following scheme:

A fiber flow controlled centrifugal bowl mechanism comprises a centrifugal bowl and a mesh filter bracket sleeved at the bottom of the centrifugal bowl; a grating disk is installed between the bottom of the centrifugal bowl and the mesh filter bracket; the upper surface of the grating disk is provided with cutting teeth; the lower part of the centrifugal bowl is provided with mesh holes allowing fibers to pass, and the mesh size is adjustable.

As an improvement of the above scheme, the mesh holes comprise first mesh holes passing through the lower part of the centrifugal bowl and second mesh holes which are located on the mesh filter bracket and are corresponding to the first mesh holes; the centrifugal bowl and the mesh filter bracket can rotate relatively along the circumference to realize adjustment of the overlapped area of the first mesh holes and second mesh holes. A plurality of first mesh holes and a plurality of second mesh holes are uniformly distributed along the circumference and a locating structure for fixing the mesh size is arranged between the centrifugal bowl and the mesh filter bracket.

This locating structure comprises a locating pin arranged on the mesh filter bracket and at least two locating holes circumferentially arranged on the wall of the centrifugal bowl; the locating pin passes through the wall of the mesh filter bracket through a compression spring and is located in the locating holes.

Compared with the prior art, the utility model has the following advantages:

1. The centrifugal bowl and mesh filter bracket of the juicer can rotate relatively to adjust the size of the mesh holes, thereby fulfilling the aim of adjusting the flow of fibers passing through the mesh holes.

2. The fiber flow can be controlled through the mesh holes, so beverages containing different fibers can be provided.

3. The mesh size can be quickly fixed by installing a locating structure, so adjustment is quick and use is convenient.

### BRIEF DESCRIPTION OF THE DRAWINGS

FIG. 1 is a structure view of an embodiment of the utility model in the exploded state.

FIG. 2 is a structural view of the embodiment in the assembled state.

### DETAILED DESCRIPTION OF THE INVENTION

To facilitate understanding of those skilled in this field, the utility model is further described with detail by reference to the attached drawings and the embodiments in combined way.

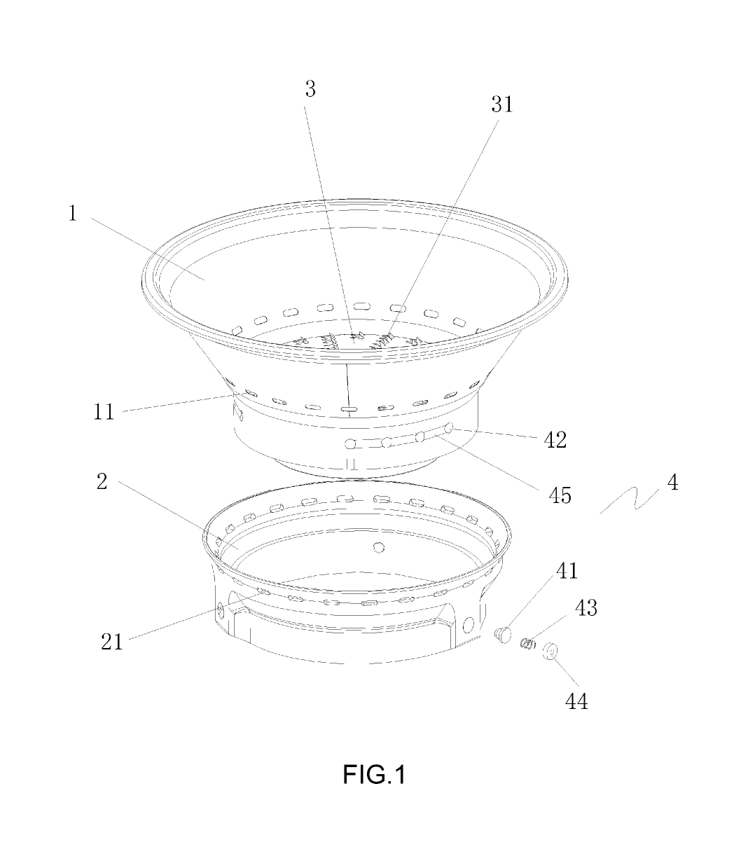

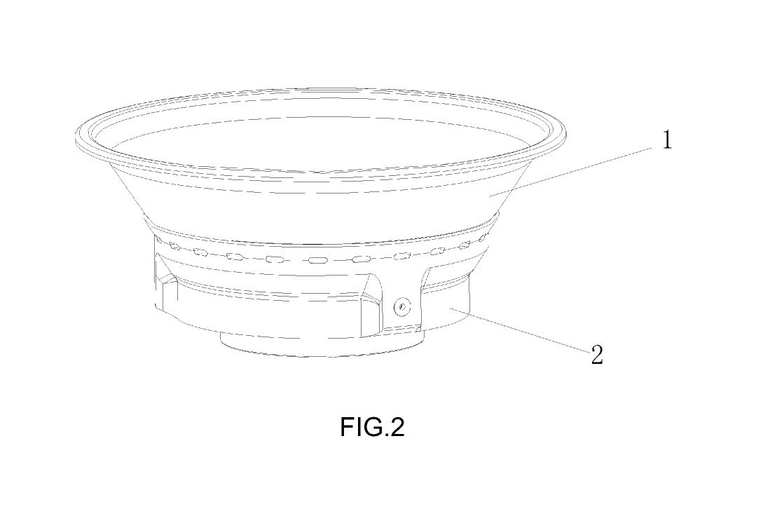

As shown in FIG. 1 and FIG. 2, the fiber flow controlled centrifugal bowl mechanism disclosed in the utility model is applicable to the adjustment of the fiber flow in the juice squeezed by the juicer, enriching the function of the juicer.

In this scheme, the fiber flow controlled centrifugal bowl mechanism comprises a centrifugal bowl 1 and a mesh filter bracket 2 sleeved at the bottom of the centrifugal bowl 1; a grating disk 3 is installed between the bottom of the centrifugal bowl 1 and the mesh filter bracket 2; the upper surface of the grating disk 3 is provided with cutting teeth 31; the lower part of the centrifugal bowl 1 is provided with mesh holes allowing fibers to pass, and the mesh size is adjustable. Specifically speaking, the mesh holes comprise first mesh holes 11 passing through the lower part of the centrifugal bowl 1 and second mesh holes 21 which are located on the mesh filter bracket 2 and are corresponding to the first mesh holes 11; the centrifugal bowl 1 and the mesh filter bracket 2 can rotate relatively along the circumference to realize adjustment of the overlapped area of the first mesh holes 11 and second mesh holes 21.

To make adjustments to the overlapped area of the first mesh holes 11 and the second mesh holes 21 convenient, a plurality of first mesh holes 11 and a plurality of second mesh holes 21 are uniformly distributed along the circumference and a locating structure 4 for fixing the mesh size is arranged between the centrifugal bowl 1 and the mesh filter bracket 2. The locating structure 4 in this embodiment comprises a locating pin 41 arranged on the mesh filter bracket and four locating holes 42 circumferentially arranged on the wall of the centrifugal bowl 1. The locating pin 41 is inserted into the wall of the mesh filter bracket 2 through a compression spring 43 and located in the locating holes 42. In order to fix the compression spring 43, the outer end of the compression spring 43 is located on an end cap 44 which is fixed on the mesh filter bracket 2. Rotate the mesh filter bracket 2, and then the locating pin 41 is located in the locating holes 42 at different positions, thereby adjusting the overlapped area of the first mesh holes 11 and second mesh holes 21. In order to ensure that the locating pin 41 smoothly slides among the locating holes 42, a sliding chute 45 is arranged among the locating holes 42; the depth of the sliding chute is smaller than those of the locating holes 42.

Specifically, for example, when the locating pin 41 is clamped at the limit position of the clockwise direction of the mesh filter bracket 2, the first mesh holes 11 and the second mesh holes 21 are completely overlapped. At this moment, the mesh holes are fully open and allow more fibers to pass. When a reduction in the flow of fibers passing through the mesh holes is required, rotate the mesh filter bracket 2 anticlockwise and then the locating pin 41 slides along the sliding chute 45 to enter another adjacent locating hole. At this moment, the overlapped area of the first mesh holes 11 and second mesh holes 21 is reduced by ⅓, and the flow of the fibers passing through the mesh holes is correspondingly reduced. If the mesh filter bracket 2 is continuously rotated anticlockwise to enable the locating pin 41 to enter the other two locating holes in turn, the overlapped area of the corresponding first mesh holes 11 and second mesh holes 21 is reduced by ⅓ in turn. When the locating pin 41 enters the locating hole at the limit position in the anticlockwise direction, there is no overlapped area between the first mesh holes 11 and the second mesh holes 21, and the mesh holes are closed. Thus, the desirable juice filtering effect and quality can be achieved by adjusting the mesh size according to different filtering objects, tastes and health needs.

In addition, aside from the specific structure and installation site of the above locating structure, the utility model also can adopt the locating structures in other forms. For example, the positions of the locating pin 41 and the locating holes 42 are exchanged, which means that the locating pin 41 is installed on the centrifugal bowl 1 while the locating holes 42 are arranged on the mesh filter bracket 2. Such structure can also fulfill the design aim.

The above structures only represent the preferable realization means of the utility model and are described in detail but cannot be accordingly used as the limit of the scope of the utility model. For those ordinarily skilled in this field, plural improvements and modifications can be made on the premise of the concept of the utility model, such as the shape, size and quantity of the mesh holes, number and distance of the locating holes, which all belong to the protective scope of the utility model. Thus, the protective scope of the utility model shall be subject to the attached claims.

What is claimed is:

1. A fiber flow controlled centrifugal bowl mechanism, comprising a centrifugal bowl (1) and a mesh filter bracket (2) sleeved at the bottom of the centrifugal bowl, wherein a grating disk (3) is installed between the bottom of the centrifugal bowl and the mesh filter bracket; the upper surface of the grating disk is provided with cutting teeth (31); characterized in that, the lower part of the centrifugal bowl is provided with mesh holes allowing fibers to pass, and the mesh size is adjustable.

2. The fiber flow controlled centrifugal bowl mechanism according to claim 1, characterized in that, said mesh holes comprises first mesh holes (11) passing through the lower part of the centrifugal bowl and second mesh holes (21) located on the mesh filter bracket and are corresponding to the first mesh holes; the centrifugal bowl and the mesh filter bracket can rotate relative to the circumference to realize adjustment of the overlapped area of the first mesh holes and second mesh holes.

3. The fiber flow controlled centrifugal bowl mechanism according to claim 2, characterized in that, a plurality of first mesh holes and a plurality of second mesh holes are uniformly distributed along the circumference; and a locating structure (4) for fixing the mesh size is arranged between the centrifugal bowl and the mesh filter bracket.

4. The fiber flow controlled centrifugal bowl mechanism according to claim 3, characterized in that, the locating structure comprises a locating pin (41) arranged on the mesh filter bracket and at least two locating holes (42) circumferentially arranged on the wall of the centrifugal bowl; and the locating pin passes through the wall of the mesh filter bracket through a compression spring (43) and is located in the locating holes.
